(19) United States
(12) Patent Application Publication
(10) Pub. No.: US 2006/0111135 A1
(43) Pub. Date: May 25, 2006

(54) Method to facilitate distribution of group identifications for push-to-talk groups

(76) Inventors: William M. Gray, Raleigh, NC (US); Gwendolyn Fournier, Durham, NC (US)

Correspondence Address: COATS & BENNETT/SONY ERICSSON, 1400 CRESCENT GREEN, SUITE 300, CARY, NC, 27511, US

(21) Appl. No.: 10/993,472

(22) Filed: Nov. 19, 2004

(51) Int. Cl. H04Q 7/00

(52) U.S. Cl. 455/519

(57) ABSTRACT

A method is provided of distributing push-to-talk group identifiers. When the PTT group is created, the user terminal for the group creator automatically generates and sends a group identification message containing the group identifier to the other group members. The user terminals receiving the message recognize that it contains a PTT group identifier and execute and group list update process to add the new group to a locally stored group list or contact list.

### BACKGROUND OF THE INVENTION

Cellular networks were originally developed to provide primarily voice services over circuit-switched networks. Although circuit-switched networks are still in widespread use, the current trend is toward packet-switched networks that provide not only voice services, but also high speed packet data services that enable mobile users to surf the web, read e-mail, download video and audio files, and do the other things that Internet users can do on fixed networks.

The IP multimedia subsystem (IMS) is a core network that is designed to provide a common, standardized architecture and standardized interfaces for IP services in a mobile networking environment. The IMS is not dependant on the access technology and will interoperate between any access network, including UMTS, CDMA 2000, GPRS, and EDGE networks. IMS uses the session initiation protocol (SIP) as the service control protocol (SCP), which allows operators to offer multiple application simultaneously. The IMS will speed the adoption of IP services on user terminals, allowing mobile subscribers to receive a full range of IP services.

Push-to-talk (PTT) is expected to be one of the first IMS-based services to be provided on a widespread basis by service operators. PTT is a half-duplex voice service wherein users press and hold a button when they speak, similar to a walkie talkie. Unlike regular voice calls, which are full duplex, PTT allows only one user to speak at a time. PTT sessions can have more than two participants. Currently proposed standards for push-to-talk over cellular (PoC) enable users to create predefined groups and to use the predefined groups to make instant group PTT calls. Each predefined group has an associated identification number or group identifier that identifies the group. All members of a particular predefined group can add the group to a “group list” or contact list stored locally in the user's terminal. The group list is a list of groups in which the user is a member. Such persistent groups make it more convenient for users to initiate a group PTT call. The user simply selects a group from the group list and presses the talk switch to immediately establish communication with other group members.

While PTT services are in high demand, the process of adding a predefined group to one's group list is unnecessarily cumbersome. The group identifier is typically long and difficult to remember. The user who creates the group must distribute the group identifier to other members. Each of the members must then manually input the group identifier to add the group to their group list. The process of distributing group identifiers manually and manually adding groups to a user's group list is cumbersome and increases the probability or error. Therefore, there is a need for a convenient method of distributing group identifiers for persistent push-to-talk groups and adding persistent PTT groups to a group list.

### SUMMARY OF THE INVENTION

The present invention provides a method implemented of distributing a group identifiers for push to talk groups and of managing group lists store in user terminals. When a user creates a new group on a group server, the group server returns a group identifier to the user that created the group, i.e the group creator. The terminal for the group creator executes a group list update process to add the new group to its locally stored group list. Additionally, the user terminal automatically generates and sends a group identification message to the other group members without the user entering the group identifier. The group identification message includes at least a group identifier and may include other group information such as a group name and the user ids and names of other group members. The user terminals for the other group members receive the group identification message and automatically update their locally stored group list, with or without prompting of the user, to include the new group and group identifier. Other than answering the prompt, the group list update process is transparently performed without the user having to manually enter the group identifier.

In one embodiment of the invention, the user terminals include a PTT client and a messaging application, such as a short message service (SMS) client. The PTT client on the user terminal creating the new group calls or sends and event to the messaging application. The messaging application then generates and sends a message including the group identifier to the other group members. The messaging client on the receiving terminal calls or sends an event to the PTT client. The call or event includes a group identifier. The PTT client for the receiving terminal can then initiate a group list update process to update the group list or contact list at the receiving terminal.

If SMS is used for distributing the group identifier, the SMS client on the receiving terminal may parse received SMS message and apply pattern matching algorithms to the received text to determine whether the SMS messages contain a group identifier. Alternatively, SMS messages could include a field in the header that is used to indicate the type of message. The group identification message may conform to an agreed upon format so that the SMS client can cull group information from the SMS message.

### BRIEF DESCRIPTION OF THE DRAWINGS

FIG. 1 is a block diagram illustrates a wireless network including an IP multimedia subsystem (IMS) for providing IP services to user terminals.

FIG. 2 is a block diagram illustrating the basic functional elements of the IMS.

FIG. 3 is a block diagram illustrating the basic architecture and service elements for PTT services

FIG. 4 is a block diagram of an exemplary user terminal according to one embodiment of the present invention.

FIG. 5 is a call flow diagram illustrating an exemplary procedure for creating a new PTT group.

FIG. 6 is a block diagram illustrating exemplary methods according to the present invention of distributing group identifiers and updating group lists.

FIG. 7 is a flow diagram illustrating an exemplary procedures according to the present invention of distributing group identifiers and updating group lists.

### DETAILED DESCRIPTION OF THE INVENTION

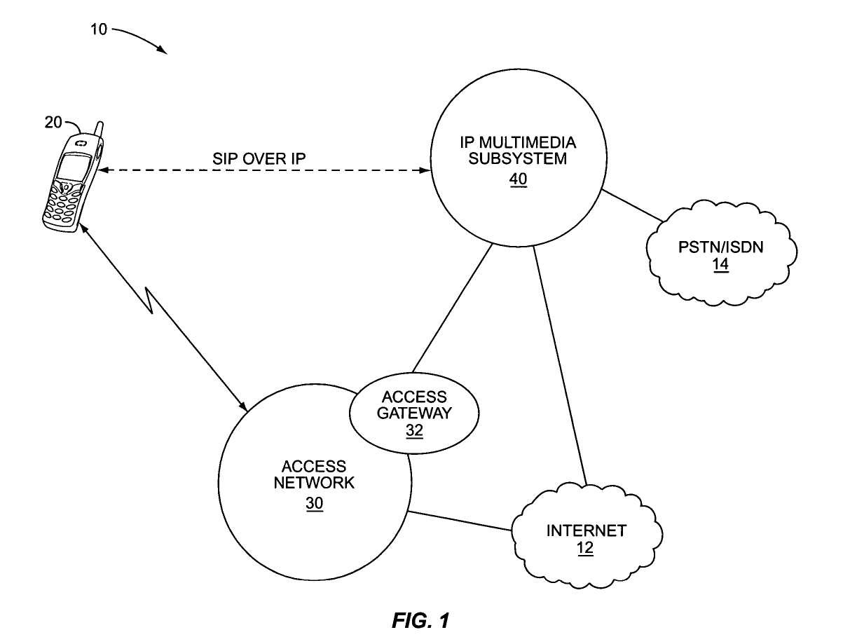

FIG. 1 illustrates a mobile communication network 10 in which the present invention may be employed. While the present invention is described in the context of a mobile communication network 10, those skilled in the art will appreciate that the present invention may also be used in fixed networks.

The mobile communication network 10 comprises a plurality of user terminals 20 (only one is shown), an access network (AN) 30 providing wireless communication services to the user terminals 20, and an IP Multimedia Subsystem (IMS) 40. The access network 30 is preferably a packet-switched network that uses any known access technology, such as TDMA or CDMA. The access network 30 may, for example, comprise a General Packet Radio Services (GPRS) network, cdma2000 network or UMTS network. The access network 30 provides a connection to the Internet 12 or other packet data network (PDN) for packet switched services such as web browsing and email, and may provide a connection to the Public Switched Telephone Network (PSTN) 14 and/or the Integrated Digital Services Network (ISDN) 16 for circuit-switched services such as voice and fax services. The access network 30 includes an access gateway 32 for interconnecting with the IMS 40. The access gateway 32 may comprise a GPRS Gateway Serving Node (GGSN) for GPRS networks or a Packet Data Serving Node (PDSN) for cdma2000 networks. The IMS 40 provides access independent, IP-based multi-media services to user terminals 20 and supports a variety of IP services including voice over IP (VoIP), video and audio streaming, email, web browsing, videoconferencing, instant messaging, push-to-talk over cellular, presence and other services.

The IMS 40 uses open interfaces and an access independent session control protocol (SCP), such as the Session Initiation Protocol (SIP), to support multi-media applications. The SIP is a session control protocol (SCP) for establishing, modifying and terminating communication sessions between one or more participants. These sessions may include, for example, Internet multimedia conferences, Internet telephony calls, and multimedia distributions. SIP is a signaling protocol that uses ASCII-based signaling messages to establish a communication session between two or more participants. Users are identified by a unique address referred to herein as the SIP address. Users register with a registrar server using their assigned SIP addresses. The registrar server provides this address to a location server upon request. SIP is described in the IETF document RFC 3261. Session description protocol (SDP) is used for media negotiation. SDP is described in IETF RFCs 2327 and 3264. While a preferred embodiment of the invention as described herein uses the SIP, those skilled in the art will appreciate that the present invention may use other SCPs as well. Another well-known protocol comparable to the SIP is H.323.

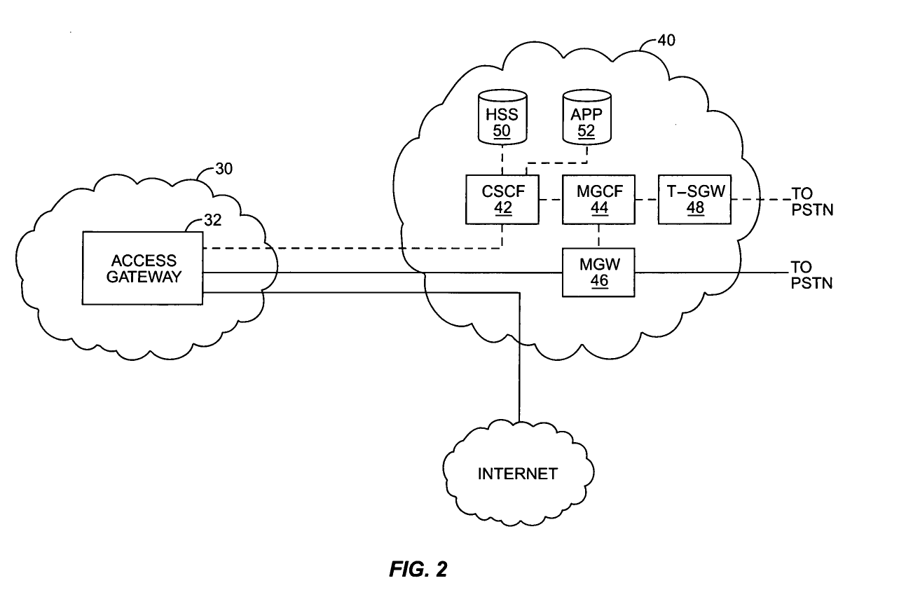

As described above, SIP enables applications within the mobile communication network 10 to establish a communications session. The applications may reside in a user terminal 20 or in an application server 52 in the IMS 40 (FIG. 2). Additionally, the applications may reside in external networks 10.

FIG. 2 illustrates the basic elements of the IMS 40. The dotted lines in FIG. 2 represent signaling messages and the solid lines represent data and/or media streams. The IMS 40 includes one or more Call State Control Functions (CSCFs) 42, a Media Gateway Control Function (MGCF) 44, a Media Gateway (MGW) 46, a Transport Signaling Gateway (T-SGW) 48, and a Home Subscriber Server (HSS) 50, which are interconnected by an IP network. The IMS 40 may further include an application server 52 providing multimedia services to user terminals 20. The application server 52 could alternatively be located in an external network. The CSCFs 42 function as SIP servers to process session control signaling used to establish, modify and terminate a communication session. Functions performed by the CSCFs 42 include call control, address translation, authentication, capability negotiation, and subscriber profile management. The HSS 50 interfaces with the CSCFs 42 to provide information about the subscriber's current location and subscription information. The application server 52 provides multimedia services or other IP services to user terminals 20. The MGCF 44, MGW 46 and T-SGW 48 support interworking with external networks, such as the PSTN or ISDN. The MGCF 44 controls one or more MGWs 46 that manage the connections between the external networks and the IMS 40. The MGCF 44 configures the MGW 46 and converts SIP messages into a different format, such as ISDN User Part (ISUP) messages. The MGCF 44 forwards the converted messages to the T-SGW 48, which interfaces the IMS 40 to external signaling network, such as the SS7 network. The T-SGW 48 includes a protocol converter to convert IP messages to SS7 and vice versa. The IMS 40 may include additional elements, which are not shown in FIG. 2 and are not important to understand the present invention.

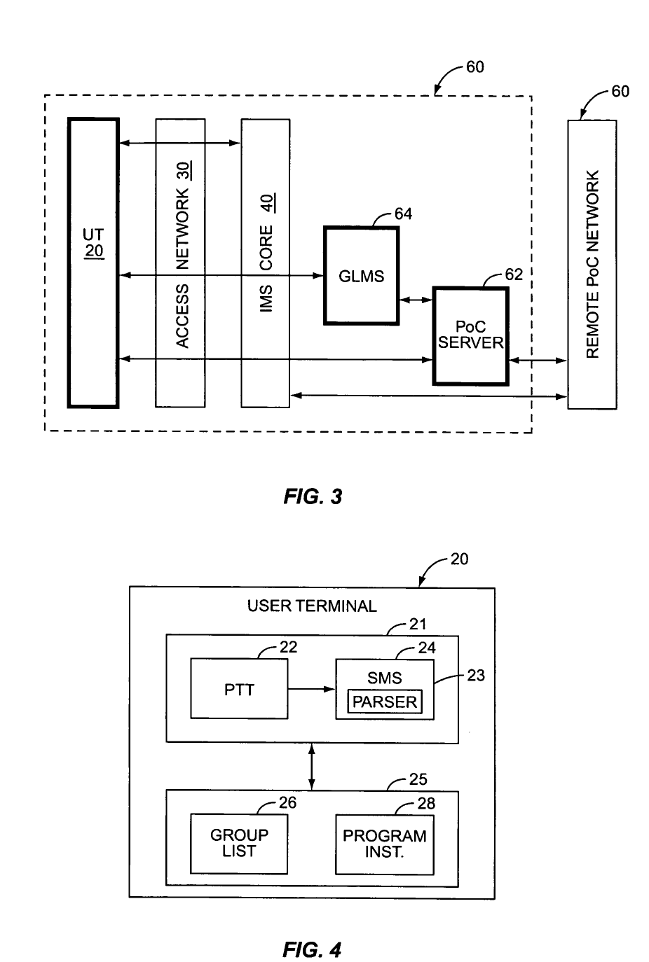

It is expected that Push-to-Talk (PTT) Over Cellular (PoC) will be one of the first IP services to be widely implemented using the IMS 40. FIG. 3 illustrates the functional elements of a PoC network 60 as described in the technical specification “Push-to-talk over Cellular (PoC); Architecture; PoC Release 2.0 (V2.0.8)” published jointly by Comneon, Ericsson, Motorola, Nokia, and Siemens. The elements shown in bold represent the basic elements of the PoC network 60. The basic elements of the PoC network include the user terminal 20, a PoC server 62, and a Group and List Management Server (GLMS) 64.

The user terminal 20, shown in FIG. 4, includes a data processing circuit 21 for executing computer programs and applications, and memory 25 for storing program instructions and data. The data processing circuit 21 may comprise one or more microprocessors, hardware, firmware, or a combination thereof. Memory 25 may be embodied in one or more memory devices, which may include both volatile (RAM) and non-volatile (ROM) memory. In the exemplary embodiment, a PTT client 22 running on a microprocessor enables PTT functionality in the user terminal and a messaging application 24 running on the same or different microprocessor enables communication with a remote user terminal 20. Memory 25 stores a group list 26 used by the PTT client. The group list is used to store a list of PTT groups to which the user belongs. Memory also stores program instructions for the PTT client 22 and SMS application 24. The PTT client 22 uses SIP to establish, modify and maintain communication sessions as defined in the Internet Engineering Task Force standard RFC 3050, 3264, 3265, 3311. The IMS routes SIP signaling between the PTT client 22 and the PoC server 62 and GLMS 64. As described in more detail below, the PTT client 22 may communicate with the messaging application 24 or other applications on the user terminal 20 using well-known interprocess communication (IPC) techniques. In the disclosed embodiment, the messaging application comprises a text messaging applications such as a Short message service (SMS). Those skilled in the art will appreciate that other messaging applications such as an instant messaging application, an email application, or a multimedia messaging application could be employed to practice the present invention.

The PoC server 62 is a network entity that provides services needed for PoC functionality, such as SIP session handling, group session handling, access control, floor control functionality, participant identification and media distribution. The PoC server 62 may function as a participating PoC server 62 or a controlling PoC server 62. The PoC server 62 is an endpoint for SIP (Session Initiation Protocol), RTP (Real-Time Transport Protocol) and RTCP (Real Time Transport Control Protocol) signaling. SIP is the protocol used for signaling to establish, modify and terminate communication sessions. RTP is the protocol used to transport voice packets and RTCP is the protocol used to perform floor control during group PTT sessions. RTCP is described in the IETF standard RFC 3550.

The GLMS 64, also referred to herein as the group server 64, is responsible for managing group lists, contact lists, and access lists associated with each user terminal. A group list is a list of PTT groups to which a user belongs. Each PTT group comprises a collection of PoC user identities defined by a user creating the group. The user creating the group is the group owner and may modify or delete the group. The group is assigned a SIP address which serves as the group identifier. The contact list is a kind of address book accessible by user terminals including addresses for other users or groups. Access lists define access restrictions for each user terminal 22. A user terminal 22 uses the access lists maintained by group server 64 to provide or deny access to other user terminals 22 for future group sessions.

During a group PTT session, all users connect to the same PoC server 62 using SIP. Once the session is established, the PoC server 62 performs floor control and media distribution. User terminals 20 request the floor from the PoC server 62, and the PoC server 62 grants it to them one at a time. The user terminal 20 holding the floor sends media to the PoC server 62, which distributes the media to the remaining participants. RTP is used for transport of voice packets and RTCP is used for floor control.

PTT groups can be ad hoc or persistent. An ad hoc group exists only for the current session and a temporary group identifier is assigned at the time the group PTT session is established. Persistent groups are stored in the GLMS 64 and have a permanent group identifier. To establish a group PTT session, the user terminal initiating the group call sends invitation to the PoC server 62 designating the called party or parties. The PTT request typically includes the SIP addresses of the called parties in the case of an ad hoc group PTT session, or the SIP address of the group in the case of an instant group PTT session. The PoC server 62 authorizes the PTT session depending on information stored in the GLMS 64, such as the access lists and Do-Not-Disturb settings of the called parties. If the PTT session is authorized, the PoC server 62 relays the invitation to the called parties and establishes the communication session once the invitation is accepted.

Using predefined groups for instant group PTT session is convenient for users, particularly for large groups, since it avoids the need to manually select individual users and/or input individual user addresses. PTT users can define groups and store their predefined groups in the GLMS 64 for use in initiating instant group PTT sessions. The GLMS 64 is responsible for group list management and implements protocols that enable PTT users to reliably create, modify, store, delete, and use groups located in the GLMS 64. Exemplary group list management protocols are described in the technical specification “Push-to-Talk over Cellular (PoC); List Management and Do-not-Disturb; PoC Release 1.0 (V1.1.3)(August 2003)” published jointly by Ericsson, Motorola, Siemens and Nokia. A text based messaging protocol, such as Hypertext Transport Protocol (HTTP) as defined in IETF RFC 2616, is used for communications between the user terminal 20 and GLMS 64. The user terminal 20 may request an action by the GLMS 64 by sending a HTTP GET request. The status of the action (passed/failed) is returned by the GLMS 64 in a HTTP response status code.

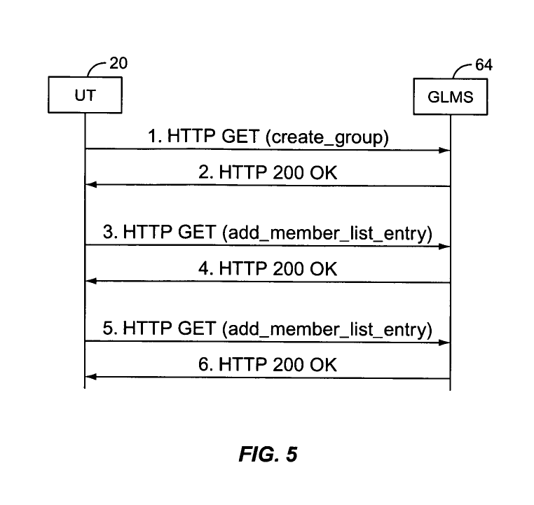

The group list management protocols typically include a method to add a group to a group list or contact list. FIG. 5 illustrates an exemplary procedure to add a new group to a group list. In the example shown in FIG. 5, the user wants to create a new group including two members in addition to himself. The user sends an HTTP GET request to the GLMS 64 to create the new group and receives a response (steps 1 and 2). The response from the GLMS 64 includes a group identifier (i.e., SIP address) in an XML body within the HTTP response. After the group is created, the user sends two HTTP GET requests to the GLMS 64 to add other users to the group and receives HTTP responses indicating the success or failure the add member process (steps 3-6). In the example shown in FIG. 5, the response indicates successful addition of two group members. Once the group is defined, any member of the group can use the new group to initiate an instant group PTT session by adding the group to a locally stored group or contact list in the user terminal. One problem with the existing standard, is that it does make any provisions for distributing the group identifier to the group participants, or updating locally stored group and contact lists in the user terminals 20.

According to the present invention, a mechanism is provided to distribute the group identifier to group members and to easily and conveniently update locally stored group and/or contact lists. When the user terminal 20 responsible for creating the group (the group creator) receives the group identifier from the GLMS 64, the user terminal 20 automatically generates and sends a group identification message to each of the members (other than himself) that were added to the group. The group identification message includes at least the group identifier. The group identification message may additionally include other information, such as a group name, user ids and names of the other group members, etc. In a preferred embodiment, the user creating the group is prompted to generate and send a group identification message to the other group members after the group is created. The user responds to the prompt indicating approval or disapproval. If the user approves, the user terminal 20 automatically generates and sends a group identification message to the other group members. Alternatively, the user terminal 20 may be configured to automatically generate and send a group identification message after the group is created without any user intervention or input.

When the group identification message is received by a user terminal 20 for one of the other group members, the user is prompted to add the new group to their locally stored group or contact list. If the user approves, an application on the user terminal 20 takes the group information from the group identification message and executes a group list update process to update the locally stored group or contact list.

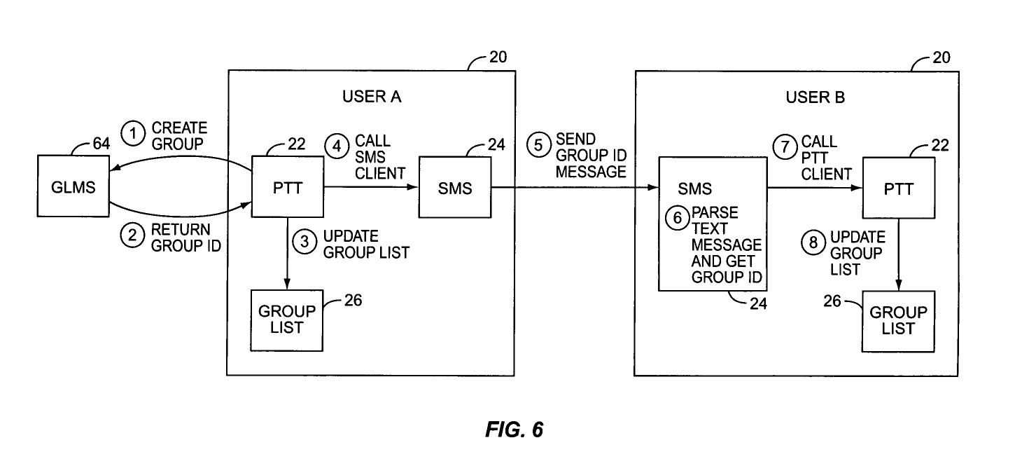

FIG. 6 illustrates in an exemplary procedure according to one embodiment of the present invention. As shown in FIG. 6, a PTT client 22 on user terminal 20 for User A requests the GLMS 64 to create a new group for user A (step 1). The GLMS 64 creates the group and returns a group identifier to the PTT client 22 (step 2). The PTT client 22 executes a group list update process to update a locally stored group list 26 or contact list (step 3). Additionally, the PTT client 22 for User A calls or sends an event to a SMS client 24 on the user terminal 20 for User A (step 4). The call or event sent by the PTT client 22 to the SMS client 24 includes at least the group identifier and may include other information, such as the group name and user ids and names for individual group members. The SMS client 24 generates and sends a group identification message to User B (step 5). In this embodiment, the group identification message comprises a standard SMS text message containing the group identifier. The SMS message may also include other group information. The SMS client 24 on the user terminal for User B includes a text parser 23 that parses the text of the SMS message and applies pattern-matching algorithms to determine whether the message contains a group identifier (step 6). If the text parser detects a group identifier, the SMS client 24 for user B sends a call or event to the PTT client 22 for user B containing at least the group identifier and optionally other group information (step 7). The PTT client 22 for User B then updates a locally stored group list or contact list 26 on the user terminal 20 for user B (step 8).

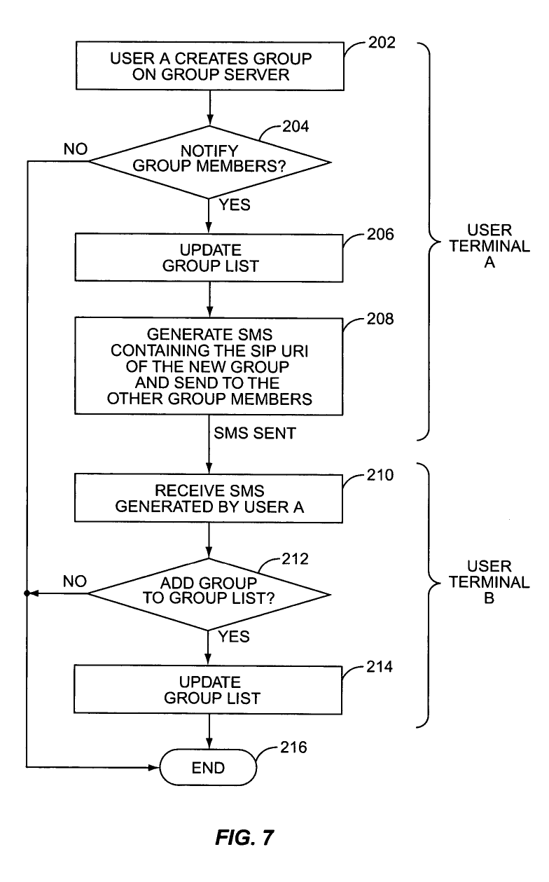

FIG. 7 is a flow diagram that illustrates procedures indicated generally at 200 for distributing group identifiers and updating group lists. User terminal A creates a group on the GLMS 64 (block 202). The user is prompted to notify other group members (block 204). If the user answers, “no” the procedure ends (block 216). If the user answer “yes,” the group list for User A is updated to include the new group (block 206) and an SMS message is generated containing the SIP address or other group identifier of the newly created group (block 208). The group identification message is received by the other group members represented collectively by User B (block 210). User B is prompted to add the group to his local group list or contact (block 212). If User B answers “no”, the procedure ends (block 216). If User B answers “yes,” the PTT client 22 on User B's user terminal 20 is invoked and performs a PoC group list update process to add the group to User B's group list (block 214). The procedure ends when the group list management process is completed by the user terminal for user B (block 216). There is no acknowledgement of the SMS of the message sent by user a to User B.

While the disclosed embodiment uses SMS messaging to distribute group identifiers, other messaging applications such as email, instant messaging and multimedia messaging could also be used. Additionally, the group identification message sent using SMS or other messaging application could contain active components that automatically execute a group list update process when selected by the user/recipient. For example, the group identification message may have a hypertext link or other type of hot link that initiates a group list update process. When the user selects the link, the group list update process is performed to add a new group to the user's group list. In other embodiments, the user may highlight text in a message and initiate the group list update process by pressing a hot key or a particular key combination. These and other techniques enable the user to perform a group list update process without having to manually enter the group identifier.

The exemplary procedures described above greatly simplify the process of distributing and updating group lists for PoC services. The methods according to the present invention requires significantly less manual entry by the user which enhances ease of use and lessens the probability of user error.

What is claimed is:

1. A method implemented by a Push-to-Talk (PTT) terminal of distributing a group identification for a PTT group comprising:
receiving a group identifier from a group server following registration of a PTT group;
generating a group identification message including said group identifier responsive to receipt of the group identifier from the group server; and
sending the group identification message to one or more group members.

2. The method of claim 1 wherein generating a group identification message comprises prompting the user responsive to receipt of the group identifier from the group server, receiving user input receive user input responsive to the user prompt, and generating a group identification message if the user input indicates approval to send a group identification message.

3. The method of claim 1 further comprising updating a group list stored in the PTT terminal responsive receipt of the group identifier from the group server.

4. The method of claim 3 wherein updating the group list comprises adding a new group to the group list and associating the group identifier with the new group.

5. The method of claim 1 wherein the group identification message comprises one of a text message, an instant message, email application and a multimedia message.

6. The method of claim 5 wherein the group identification message includes an active component that can be triggered by the recipient to automatically update the recipient's group list with a new group associated with the group identifier.

7. A method implemented by a Push-to-Talk (PTT) terminal of updating a group list for storing persistent PTT groups, comprising:
receiving a group identification message including a group identifier; and
updating a group list stored in the PTT terminal responsive to receipt of the group identification message to include a new group and associating the group identifier with the new group.

8. The method of claim 7 wherein updating a group list comprises prompting the user responsive to receipt of the group identification message, receiving user input responsive to the prompt, and updating the group list if the user input indicates approval.

9. The method of claim 7 wherein the group identification message is received by a messaging application on the PTT terminal.

10. The method of claim 9 wherein updating the group list comprises detecting the group identifier in the group identification message by the messaging application, sending the group identifier from the messaging application to a PTT application, and updating the group list by the PTT application.

11. The method of claim 10 wherein the messaging application comprises one of a text messaging application, instant messaging application, email application and multimedia messaging application.

12. The method of claim 7 wherein the group identification message includes an active component that when selected by the recipient causes a new group to be added to the user's group list.

13. A user terminal comprising:
memory to store a group list for PTT groups;
a processing circuit configured to:
register a PTT group with a group server;
receive a group identifier from the group server responsive to registration of the PTT group;
generate a group identification message including said group identifier following receipt of the group identifier from the group server; and
send the group identification message to one or more group members.

14. The user terminal of claim 13 wherein the processor generates a group identification message by prompting the user responsive to receipt of the group identifier from the group server, receiving user input responsive to the user prompt, and generating a group identification message if the user input indicates approval to generate a group identification message.

15. The user terminal of claim 13 further comprising updating a group list stored in the PTT terminal responsive receipt of the group identifier from the group server.

16. The user terminal of claim 16 wherein the processing circuit updates the group list by adding a new group to the group list and associating the group identifier with the new group.

17. The user terminal of claim 13 wherein the group identification message comprises one of a text message, an instant message, email application and a multimedia message.

18. The user terminal of claim 17 wherein the group identification message includes an active component that can be triggered by the recipient to automatically update the recipient's group list with a new group associated with the group identifier.

19. A user terminal comprising:
memory to store a group list for PTT groups;
a processing circuit configured to:
receive a group identification message including a group identifier; and
update a group list stored in the PTT terminal responsive to receipt of the group identification message to include a new group and associating the group identifier with the new group.

20. The user terminal of claim 19 wherein the processing circuit updates the group list by prompting the user responsive to receipt of the group identification message, receiving user input responsive to the user prompt, and updating the group list if the user input indicates approval to update the group list.

21. The user terminal of claim 19 wherein the group identification message is received by a messaging application on the PTT terminal.

22. The user terminal of claim 21 wherein updating the group list comprises detecting the group identifier in the group identification message by a messaging application, passing the group identifier from the messaging application to a second application, and updating the group list by the second application.

23. The user terminal of claim 22 wherein the second application is a PTT application.

24. The user terminal of claim 22 wherein the messaging application comprises one of a text messaging application, instant messaging application, email application and multimedia messaging application.

25. The user terminal of claim 19 wherein the group identification message includes an active component that when selected by the recipient causes a new group to be added to the user's group list.

26. A computer readable media containing a computer program, said computer program comprising code to:
register a PTT group with a group server;
receive a group identifier from the group server responsive to registration of the PTT group;
generate a group identification message including said group identifier following receipt of the group identifier from the group server; and
send the group identification message to one or more group members.

27. The computer readable media of claim 26 wherein the computer program further comprises code to prompt the user responsive to receipt of the group identifier from the group server, receive user input responsive to the user prompt, and generate a group identification message if the user input indicates approval to send a group identification message.

28. The computer readable media of claim 26 further comprising code to update a group list stored in a user terminal responsive receipt of the group identifier from the group server.

29. The computer readable media of claim 28 further comprising code to add a new group to a group list stored on the user terminal and associate the group identifier with the new group.

30. The computer readable media of claim 26 wherein the group identification message comprises one of a text message, an instant message, email application and a multimedia message.

31. The computer readable media of claim 30 wherein the group identification message includes an active component that can be triggered by the recipient to automatically update the recipient's group list with a new group associated with the group identifier.

32. A computer readable media containing a computer program comprising code to:
add a new group to a group list stored in a user terminal responsive to receipt of a group identification message containing a group identifier,
associate the group identifier with the new group.

33. The computer readable media of claim 32 further comprising code to prompt the user to add a new group to the group list responsive to receipt of the group identification message, to receive user input responsive to said prompt, and to update said group list if the user input indicates approval to update the group list.

34. The computer readable media of claim 32 wherein the computer program stored in the computer readable media comprises a messaging application to receive the group identification message, and a second application to update the group list.

35. The computer readable media of claim 34 wherein the messaging application includes code to detect the group identifier in the group identification message, and to pass the group identifier from the messaging application to the second application.

36. The computer readable media of claim 35 wherein the second application is a PTT application.

37. The computer readable media of claim 34 wherein the messaging application comprises one of a text messaging application, instant messaging application, email application and multimedia messaging application.
